(19) United States
(12) Patent Application Publication
(10) Pub. No.: US 2018/0322214 A1
(43) Pub. Date: Nov. 8, 2018

(54) DATA DISPLAY METHOD

(71) Applicant: SHENZHEN YOUBESS TECH SERVICE CO., LTD, SHENZHEN (CN)

(72) Inventor: SHOUDONG FANG, SHENZHEN (CN)

(73) Assignee: SHENZHEN YOUBESS TECH SERVICE CO., LTD

(21) Appl. No.: 15/588,697

(22) Filed: May 8, 2017

(51) Int. Cl. G06F 17/30; G06K 9/00; G06K 19/06; G06K 7/14

(52) U.S. Cl. CPC G06F 17/30879; G06K 9/00469; G06K 7/1417; G06F 17/30867; G06K 19/06037; G06F 17/30424

(57) ABSTRACT

The present invention provides a data display method comprising the following steps: Step 1, becoming a new user through scanning QR code of an upper level user, direct signing-up or third party login; Step 2, the new user becomes a subordinate user of the superior user, and the system gives the coordinate to the new user according to the number of original subordinate users of the superior user and the situation of levels; Step 3, calculating a coordinate distance between the coordinate of the new user and the selected coordinate; Step 4, calculating the coordinate distance of the new user, and sorting the coordinate distances calculated for all users from small to large; Step 5, if the coordinate distances are the same, sorting the information based on the latest time of releases.

### TECHNICAL FIELD

The present invention belongs to the field of data search technique, more particularly, to a data display method.

### BACKGROUND OF THE PRESENT INVENTION

Currently, Internet has increasingly developed, Internet access has become our daily life, we often employ an explorer to search key words for the information we are expecting, for example, when we use Taobao to purchase some commodities, some information of these commodities we are expecting is often acquired by searching keywords, and amounts of searching results may be obtained when the user search with keywords, however, unfairness of information can occur no matter how to sort those searching results, since that, “Dian Xiao Er (waiter)” emerges, who can provides such crucial data of the competitors as shop browsing number, browsing depth, in-store stay, re-browsing rate etc., and also can sell those products with a low price, even in inferior quality, for a high price, thereby causing an outstanding problem of unfair competition.

### SUMMARY OF PRESENT INVENTION

For above technical problem, the present invention provides a data display method, which has a justice sorting for data information, and everyone has an opportunity to rank in front of the searching results with a fair competition.

To achieve above purpose, the present invention employs a data display method below, characterized by comprising the following steps:

Step 1, becoming a new user through scanning QR code of an upper level user, direct signing-up or third party login;

Step 2, the new user becomes a subordinate user of the superior user, and the system gives the coordinate to the new user according to the number of original subordinate users of the superior user and the situation of levels;

Step 3, calculating a coordinate distance between the coordinate of the new user and the selected coordinate;

Step 4, calculating the coordinate distance of the new user, and sorting the coordinate distances calculated for all users from small to large;

Step 5, if the coordinate distance are the same, sorting the information based on the latest time of releases.

Further, the Step 2 is described in detail as: providing the new user a five-dimensional coordinate (a, b, c, d, e), in which a is the ordinal number of first-level upper level user, b is the ordinal number of second-level upper level user, c is the ordinal number of third-level upper level user, d is the ordinal number of fourth-level upper level user and e is the ordinal number of fifth-level upper level user; then, calculating the coordinate distance between the five-dimensional coordinate (a, b, c, d, e) of the new user and a selected five-dimensional coordinate (A, B, C, D, E).

Further, calculating the coordinate distance between the five-dimensional coordinate (a, b, c, d, e) of the new user and a selected five-dimensional coordinate (A, B, C, D, E) is described in detail as:

S1, comparing any one five-dimensional coordinate (a1, b1, c1, d1, e1) with the selected five-dimensional coordinate (A, B, C, D, E), with (a1, b1, c1, d1, e1) as the starting point of the coordinate and (A, B, C, D, E) as the ending point of the coordinate;

S2, comparing two sets of five-dimensional coordinates from the first dimension thereof, using 0 to indicate if the two values are the same and using 1 to indicate if not, and after finding the first difference therebetween, for the remaining dimensions, using 0 to indicate if the coordinate value is 0 and using 1 to indicate if not;

S3, adding the results of comparison of two sets of five-dimensional coordinates separately to obtain a base level number M of the starting coordinate and a base level number N of the ending coordinate respectively;

S4, a five-dimensional coordinate distance (MN) is obtained based on the base level number M of the starting coordinate being in the front and the base level number N of the ending coordinate being in the post;

Based on above principle, a coordinate distance (M′N′) between the five-dimensional coordinate (a, b, c, d, e) of the new user and the selected five-dimensional coordinate (A, B, C, D, E) is obtained, and then sorting the five-dimensional coordinate distance (MN) calculated for all users from small to large;

Further, the range of five-dimensional coordinate distance (MN) may be defined, and be sorted after being filtered according to the query information.

Further, the selected five-dimensional coordinate (A, B, C, D, E) is (98, 43, 22, 0, 0) or (1, 10, 55, 1, 0) or (33, 66, 71, 52, 1).

The present invention has a beneficial effect in that: it can efficiently improve the injustice sorting of information; one can obtain a five-dimensional coordinate belonging to himself no matter he is an upper level user or new user, and his superior one is determined by the five-dimensional coordinate, sorting the user information with the same coordinate distance according to the latest release after sorting from small to large base on the coordinate distance; the sorting process is neither artificial nor changed due to the price factor, giving everyone an equal opportunity to come in the front regardless of doing affectedly, and only when the coordinate distance is same can latest sorting be conducted according to time. After searching, though sorting according to the network distance results a same set, different sorting may occur due to different searchers, and it is more objective, fair for one being searched to have an opportunity to rank in front.

### DESCRIPTION OF THE DRAWINGS

FIG. 1 is a flow chart of the method in the present invention.

### DETAILED DESCRIPTION OF PREFERRED EMBODIMENTS

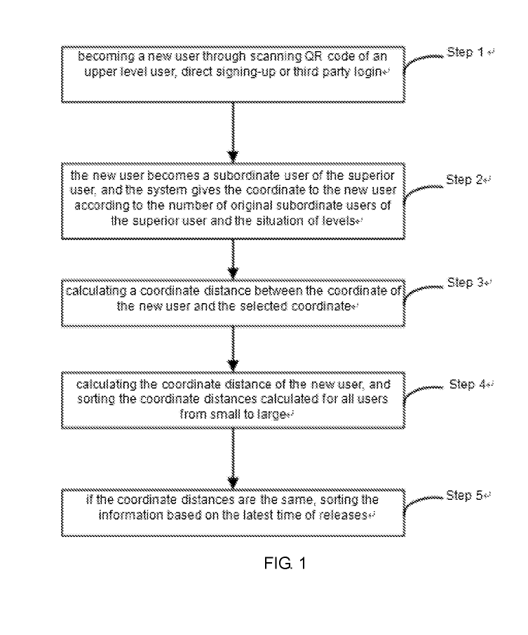

The operation method of the present invention will be described in detail through following specific embodiments, as shown in FIG. 1.

The present invention employs a tree structure of user, in which every level is disposed with a plurality of parallel nude users, every superior sub-level at the same level has subordinate sub-levels, each node user of superior sub-level has a plurality of node users of subordinate sub-level.

Wherein, specific formation method can refer to the followings:

Step 1, becoming a new user through scanning QR code of an upper level user, direct signing-up or third party login;

Step 2, the new user becoming a subordinate user of the superior user, and the system gives the coordinate to the new user according to the number of original subordinate users of the superior user and the situation of levels;

Specifically: each third party becomes a new user after QR coding on its superior user and registering, login, the subordinate users number of the superior user +1 after adding a new user according to the number of original subordinate users of the superior user, then a five dimensional coordinate (a, b, c, d, e) of the new user is formed, in which, a is the ordinal number of first-level upper level user, b is the ordinal number of second-level upper level user, c is the ordinal number of third-level upper level user and so on,

For example, if the five-dimensional coordinate of the superior user is (1, 2, 0, 0, 0), the superior user is a second-level user; if the number of original subordinate users of the superior user is 20, the generated five-dimensional coordinate value of a new user is (1, 2, 21, 0, 0); if the five-dimensional coordinate value of the user is (1, 20, 33, 2, 0), the superior user is a fourth-level user; if the number of original subordinate users of the superior user is 66, the generated five-dimensional coordinate value of a new user is (1, 20, 33, 2, 67).

Step 3, calculating a coordinate distance between the coordinate of the new user and the selected coordinate;

Now how a newly-registered user calculates the coordinate distance between the new user and the selected five-dimensional coordinate (A, B, C, D, E) will be described in detail, and firstly, the corresponding principles as follows:

Comparing any one five-dimensional coordinate (a1, b1, c1, d1, e1) with the selected five-dimensional coordinate (A, B, C, D, E), with (a1, b1, c1, d1, e1) as the starting coordinate and (A, B, C, D, E) as the ending coordinate, for example, a five-dimensional coordinate (98, 33, 12, 20, 0) serves as the starting coordinate and another selected five-dimensional coordinate (98, 43, 22, 0, 0) serves as the ending coordinate, and of course, the selected five-dimensional coordinate may be any designated one such as (1, 10, 55, 1, 0) or (33, 66, 71, 52, 1);

Comparing two sets of five-dimensional coordinates from the first dimension thereof, using 0 to indicate if the two values are the same and using 1 to indicate if not, and after finding the first difference, using 0 to indicate if the coordinate value of the remaining dimensions is 0 and using 1 to indicate if not, and the results acquired when (98, 33, 12, 20, 0) is the starting coordinate and (98, 43, 22, 0, 0) is the ending coordinate are as follows;

| starting and ending | results after |
|---|---|
| coordinate | comparison |
| starting point (98, 33, 12, 20, 0) | 0 + 1 + 1 + 1 + 0 |
| ending point (98, 43, 22, 0, 0) | 0 + 1 + 1 + 0 + 0 |

The results acquired, for example, when (10, 12, 26, 17, 2) is the starting coordinate and (98, 43, 22, 0, 0) is the ending coordinate, are as follows:

| starting and ending | results after |
|---|---|
| coordinate | comparison |
| starting point (98, 33, 12, 20, 2) | 1 + 1 + 1 + 1 + 1 |
| ending point (98, 43, 22, 0, 0) | 1 + 1 + 1 + 0 + 0 |

Adding the values of the compared results of two sets of five-dimensional coordinates separately to obtain a base level number M of the starting coordinate and a base level number N of the ending coordinate, and the results acquired from above examples are as follows:

| starting and ending | |
|---|---|
| coordinate | base level number |
| starting point (98, 33, 12, 20, 0) | 3 |
| ending point (98, 43, 22, 0, 0) | 2 |

| starting and ending | |
|---|---|
| coordinate | base level number |
| starting point (98, 33, 12, 20, 2) | 5 |
| ending point (98, 43, 22, 0, 0) | 3 |

A five-dimensional coordinate distance (MN) is obtained based on the base level number M of starting coordinate being in the front and the base level number N of ending coordinate being in the post; so the five-dimensional coordinate distances obtained from above example are (32) and (53).

Seen from above, for the upper level one and lower level one, for example, if the coordinate of a second-level user is (1, 2, 0, 0, 0), the coordinate of a corresponding third-level user must be (1, 2, X, 0, 0), wherein X can't be 0, and the results from comparison are as follows:

| starting and ending | results after |
|---|---|
| coordinate | comparison |
| second-level (1, 2, 0, 0, 0) | 0 + 0 + 0 + 0 + 0 |
| third-level (1, 2, X, 0, 0) | 0 + 0 + 1 + 0 + 0 |

results:

| starting and ending | |
|---|---|
| coordinate | base level number |
| second-level (1, 2, 0, 0, 0) | 0 |
| third-level (1, 2, X, 0, 0) | 1 |

Thus, the five-dimensional coordinate distance from upper level user to lower level user is always (01), the five-dimensional coordinate distance from lower level user to upper level user is always (10), the maximum five-dimensional coordinate distance is (55) when, for example, (1, 1, 1, 1, 1) serves as a starting coordinate and (2, 2, 2, 2, 2) serves as an ending coordinate, and the minimum five-dimensional coordinate distance is (00) when, for example, (1, 1, 1, 1, 1) serves as a starting coordinate and (1, 1, 1, 1, 1) serves as an ending coordinate or (11, 12, 13, 14, 15) serves as a starting coordinate and (11, 12, 13, 14, 15) serves as an ending coordinate, thereby the user himself can be obtained.

Step 4, calculating the coordinate distance of the new user, and sorting the coordinate distances calculated for all users from small to large;

If the five-dimensional coordinate of newly-registered user is (1, 2, 21, 0, 0) and the selected five-dimensional coordinate is (2, 2, 2, 2, 2), the coordinate distance obtained is (25), and the five-dimensional coordinate of the remaining users serves as the starting coordinate with the selected five-dimensional coordinate (2, 2, 2, 2, 2) serving as an ending coordinate, the coordinate distance (MN) of all users can be obtained and a sorting of the five-dimensional coordinate distance (MN) from small to large can be formed.

Step 5, if the coordinate distances are the same, sorting the information based on the latest time of releases;

The range of the five-dimensional coordinate distance (MN) may be defined, in which any distances between (00)-(55) can be selected, and be sorted after being filtered according to the query information.

For example, different five-dimensional coordinate distances (X1,X2) are selected according to different time period such that information of five-dimensional coordinate (X1,X2) calculated for both all users and the selected starting coordinate are released simultaneously within a certain period of time.

The present method utilizes “coordinate” in mesh structure to substitute “user ID” in oblate structure, and marks Internet user with coordinate to constitute a mesh user structure as a base for calculating network distance, thus it solves not only such problems that a real network structure can't be achieved and even the distance can't be calculated by a traditional network user who simulates the network structure with ID in oblate structure, but also makes such network activities as searching across application, platform, sorting, communication, transaction etc. become possible. Coordinate and algorithm will improve increasingly, and even enrich and improve user's experience by network relations produced from network activities.

Embodiments of the present invention are only described in detail, which is not aiming at limiting its protection scope. Certain modifications may be conducted by those skilled in the art in light of the embodiments of the present invention, therefore all equivalent modifications or ornaments conducted according to the scope of the present invention are within the claims of the present invention.

I claim:

1. A data display method, comprising the following steps:
Step 1, becoming a new user through scanning QR code of an upper level user, direct signing-up or third party login;
Step 2, making the new user to become a subordinate user of the superior user, and making the system to give the coordinate to the new user according to the number of original subordinate users of the superior user and the situation of levels;
Step 3, calculating a coordinate distance between the coordinate of the new user and the selected coordinate;
Step 4, calculating the coordinate distance of the new user, and sorting the coordinate distances calculated for all users from small to large;
Step 5, if the coordinate distances are the same, sorting the information based on the latest time of releases.

2. The data display method according to claim 1, wherein the Step 2 are described in detail as: providing the new user a five-dimensional coordinate (a, b, c, d, e), and
calculating the coordinate distance between the five-dimensional coordinate (a, b, c, d, e) of a new user and a selected five-dimensional coordinate (A, B, C, D, E).

3. The data display method according to claim 2, wherein the step “calculating the coordinate distance between the five-dimensional coordinate (a, b, c, d, e) of a new user and a selected five-dimensional coordinate (A, B, C, D, E)” is described in detail as:
S1, comparing any one five-dimensional coordinate (a1, b1, c1, d1, e1) with the selected five-dimensional coordinate (A, B, C, D, E), with (a1, b1, c1, d1, e1) as a starting point of the coordinate and (A, B, C, D, E) as an ending point of the coordinate;
S2, comparing two sets of five-dimensional coordinates from the first dimension thereof, using 0 to indicate if the two values are the same and using 1 to indicate if not, and after finding the first difference therebetween, for the remaining dimensions, using 0 to indicate if the coordinate value is 0 and using 1 to indicate if not;
S3, adding the results of comparison obtained of two sets of five-dimensional coordinates separately to obtain a base level number M of the starting coordinate and a base level number N of ending coordinate respectively;
S4, a five-dimensional coordinate distance (MN) is obtained based on the base level number M of the starting coordinate being in the front and the base level number N of the ending coordinate being in the post;
obtaining a coordinate distance (M′N′) between the five-dimensional coordinate (a, b, c, d, e) of the new user and the selected five-dimensional coordinate (A, B, C, D, E) based on above principle, and then
sorting the five-dimensional coordinate distance (MN) calculated for all users from small to large.

4. The data display method according to claim 3, wherein a range of five-dimensional coordinate distance (MN) may be defined, and be sorted after being filtered according to the query information.

5. The data display method according to claim 4, wherein the selected five-dimensional coordinate (A, B, C, D, E) is (98, 43, 22, 0, 0) or (1, 10, 55, 1, 0) or (33, 66, 71, 52, 1).
